(19) United States
(12) Patent Application Publication
(10) Pub. No.: US 2020/0353730 A1
(43) Pub. Date: Nov. 12, 2020

(54) ENERGY SAVING FILM STRUCTURE

(71) Applicant: NAN YA PLASTICS CORPORATION, Taipei (TW)

(72) Inventors: TE-CHAO LIAO, TAIPEI (TW); CHUN-CHE TSAO, TAIPEI (TW); Chia-Ho Cheng, TAIPEI (TW)

(21) Appl. No.: 16/827,781

(22) Filed: Mar. 24, 2020

(30) Foreign Application Priority Data
May 10, 2019 (TW) 108116148

(51) Int. Cl. B32B 27/30; B32B 27/36; B32B 7/06; B32B 7/12; B32B 27/18

(52) U.S. Cl. CPC B32B 27/304; B32B 27/36; B32B 7/06; B32B 7/12; B32B 2307/584; B32B 2307/304; B32B 2307/412; B32B 2264/105; B32B 27/18

(57) ABSTRACT

An energy-saving film structure includes a transparent fluorocarbon insulation, a PET substrate layer, an UV absorbing adhesive layer and a release film. The transparent fluorocarbon insulation not only has excellent infrared shielding rate but also has excellent weather resistance, and the layer is bonded to the PET substrate layer. The UV absorbing adhesive layer is attached to the release film on one side and to the PET substrate layer on the other side.

### CROSS-REFERENCE TO RELATED PATENT APPLICATION

This application claims the benefit of priority to Taiwan Patent Application No. 108116148, filed on May 10, 2019. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an energy saving film structure, and more particularly to a clear and transparent energy saving film structure having an outer surface with mirror-like cleanliness and a beautiful aesthetic. In addition, a fluorocarbon material has good weather resistance and scratch resistance, so that the energy saving film structure has both self-cleaning and flame retardant functions. Conventional thermal insulation materials basically use a near-infrared short-wave blocking nano material dispersion doped with antimony-doped tin oxide (ATO) or tin-doped indium oxide (ITO). However, these two materials can only block a long-wave part of the near-infrared radiation, that is, they can only block part of a solar heat radiation, and the heat insulation effect is not ideal. Inorganic blocking nano particles selected in the present disclosure impart an excellent infrared shielding function to the energy saving film, thereby making the energy saving film structure suitable for locations requiring high heat insulation in materials. Therefore, the energy saving film structure can be applied to buildings with high requirements for UV resistance, such as places upon which the summer sun shines directly, and even to transports such as sea and air transportation.

### BACKGROUND OF THE DISCLOSURE

Glass has become an indispensable part of life, especially in the architectural industry. There are more and more functional requirements for glass. In addition to existing glass functions, additional functions such as glass insulation, shading and filtration are also required so as to provide the features of being UV-friendly, environmentally friendly, energy-saving, healthy and stylish.

At present, insulating glass generally uses hollow and vacuum glass for heat insulation, and shaded glass uses low-emissivity (Low E) glass, both of which generally have a relatively simple function. The Low E glass tends to oxidize easily, resulting in poor shading, heat insulation, and short service life. In addition, existing glass is fragile, and is not ideal for practical considerations such as safety performance.

In order to achieve the functions of heat insulation, shading, ultraviolet filtering, etc., expensive construction costs are often required. For most old buildings, remodeling could turn out to be a vast and costly endeavor. By means of attachment, the film structure of the present disclosure can provide common glass with energy saving, heat insulating, shading, ultraviolet filtering and explosion-proof functions, facilitate convenient construction, and provide low costs and long durability.

### SUMMARY OF THE DISCLOSURE

In response to the above-referenced technical inadequacies, the present disclosure provides an energy saving film structure, in particular to an outdoor film containing fluorocarbon resin. The technical issue to be solved is related to directly coating a fluorocarbon transparent heat-insulating coating with good heat insulation effect on the surface of a polyethylene terephthalate (PET) substrate. The energy saving film structure includes a first layer, a second layer, a third layer, and a fourth layer which are sequentially arranged. The first layer is a transparent fluorocarbon insulation, the second layer is a PET substrate layer, and the third layer is an UV absorbing adhesive layer, and the fourth layer is a release film attached to the UV absorbing adhesive layer.

In one aspect, the present disclosure provides a fluorocarbon insulation including, by weight percentage, 25 to 55 wt % of fluorocarbon resin, 30 to 65 wt % of infrared blocking nano material dispersion, 1 to 15 wt % of nano scratch resistant material dispersion, 0.01 to 1.2 wt % of leveling agent, and 15 to 40 wt % of mixed solvent.

The fluorocarbon resin is a fluoropolymer, preferably polyvinyl fluoride. By using fluorocarbon resin layer with good stain resistance, high temperature resistance, oxidation resistance, weather resistance and radiation resistance, it can be ensured that PET substrate layer does not decompose and crack, and the product has no irritating odor, and does not exhibit a yellowing effect when used outdoors for a long time.

The infrared blocking nano material dispersion has a solid content of 20 to 40 wt %. The infrared blocking nano material dispersion is a dispersion of a composite metal tungsten oxychloride doped with antimony, tin, antimony, bismuth or a combination thereof. An average particle diameter of the infrared blocking nano material dispersion is from 30 nm to 100 nm.

The nano scratch resistant material dispersion is silicone acrylate-modified nano silica. An average particle diameter of the nano scratch resistant material dispersion is from 20 nm to 120 nm.

The leveling agent is a polyfluorocarbon-modified organosilicone compound.

The mixed solvent is selected from one or any combination of propylene glycol methyl ether acetate, methyl ethyl ketone, toluene, xylene, butyl acetate, n-butanol, methyl acetate, ethylene glycol butyl ether, ν, ν-dimethylformamide (dmf), γ-butyl Lactone, ν, ν-dimethylacetic acid amine (dmac), dimethyl phthalate (dmp), and hexamethylphosphoniumamine.

The purpose of the present disclosure is to solve problems that the thermal insulation film of the related art has poor heat insulation effect, has a shielding efficiency against infrared of only 50%, is not being able to withstand long-term outdoor sun and rain, and can only be used indoors. Not to mention the purpose of self-cleaning, and high barrier against ultraviolet and infrared

A four-layer structure, from the outside to the inside, is composed of fluorocarbon insulation (a film layer of a combination of a polyvinyl fluoride and a nano infrared barrier material), a PET substrate layer, an UV absorbing adhesive layer, and a release film After blending the polyvinyl fluoride and the nano infrared barrier material into a coating liquid, the coating is directly applied to one side of the PET substrate, and the UV absorbing adhesive is applied to the other side of the PET substrate relative to another side of the infrared barrier layer, and the release film is then coated on the UV absorbing adhesive layer to protect an adhesive layer.

In the above combination, a film layer composed of the polyvinyl fluoride and the infrared blocking nano material has visible light transparency. The superior weather resistance of the polyvinyl fluoride resin and the infrared light blocking function contributed by the infrared blocking nano material fully block the damage to the PET substrate layer by ultraviolet rays and infrared rays, and provide the best protection of the PET substrate layer.

In addition to protecting an adhesive bonding layer, the UV absorbing adhesive layer blocks nearly 100% of UV radiation to an interior, ensuring that contents of a room are protected from UV damage. The adhesive bonding layer also provides the function of firmly bonding to an inorganic glass or an attached material. A composite film has good heat insulation, heat preservation effect, and can be used outdoors for a long time, and has the advantages of good energy saving performance and easy construction.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a schematic view of an energy saving film structure of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

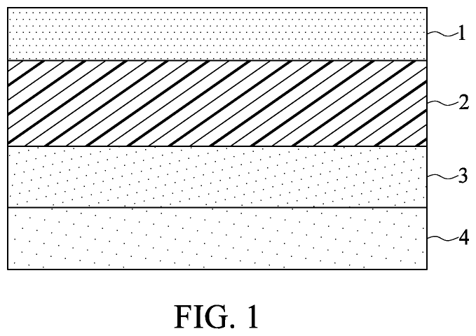

Referring to FIG. 1, a first embodiment of the present disclosure provides a four-layer composite structure, which is sequentially composed of a fluorocarbon insulation (a film layer of a combination of a polyvinyl fluoride and a nano infrared barrier material), a PET substrate layer, an UV absorbing adhesive layer, and a release film After blending the polyvinyl fluoride and the nano infrared barrier material into a coating liquid, the coating is directly applied to one side of the PET substrate, and the UV absorbing adhesive is applied to the other side of the PET substrate relative to another side of the infrared barrier layer, and then the release film is coated on the UV absorbing adhesive layer to protect an adhesive layer.

In the first embodiment, the film layer of the polyvinyl fluoride and the nano infrared barrier material is composed of the following components by weight: 30 wt % of fluorocarbon resin; 30 wt % of inorganic blocking nano material dispersion, whose average particle diameter is from 30 nm to 100 nm; 10 wt % of the nano scratch resistant material dispersion, whose average particle diameter is from 20 nm to 120 nm; 0.5 wt % of a leveling agent (or a rheological agent); and 29.5 wt % of a mixed solvent.

### Second Embodiment

Referring to FIG. 1, a second embodiment of the present disclosure provides a four-layer composite structure, which is sequentially composed of a film layer of a combination of a polyvinyl fluoride and a nano infrared barrier material, a PET substrate layer, an UV absorbing adhesive layer, and a release film After blending the polyvinyl fluoride and the nano infrared barrier material into a coating liquid, the coating is directly applied to one side of the PET substrate, and the UV absorbing adhesive is applied to the other side of the PET substrate relative to another side of the infrared barrier layer, and then the release film is coated on the UV absorbing adhesive layer to protect an adhesive layer. Compared to the first embodiment, the present embodiment increases the weight percentage of the infrared blocking nano material dispersion.

In the second embodiment, the film layer of the polyvinyl fluoride and the nano infrared barrier material is composed of the following components by weight: 35 wt % of fluorocarbon resin; 50 wt % of inorganic blocking nano material dispersion, whose average particle diameter is from 30 nm to 100 nm; 10 wt % of the nano scratch resistant material dispersion, whose average particle diameter is from 20 nm to 120 nm; 0.5 wt % of a leveling agent; and 9.5 wt % of a mixed solvent.

### Comparative Example 1

Referring to FIG. 1, a comparative example 1 provides a four-layer composite structure, which is sequentially composed of a film layer of a combination of a PMMA resin and a nano infrared barrier material, a PET substrate layer, an UV absorbing adhesive layer, and a release film After blending a polyvinyl fluoride (such as PMMA resin) and the nano infrared barrier material into a coating liquid, the coating is directly applied to one side of the PET substrate, and the UV absorbing adhesive is applied to the other side of the PET substrate relative to another side of the infrared barrier layer, and then the release film is coated on the UV absorbing adhesive layer to protect an adhesive layer. Compared to the second embodiment, the comparative example replaced a polyvinyl fluoride resin with the PMMA resin.

In the second embodiment, the film layer of the polyvinyl fluoride and the nano infrared barrier material is composed of the following components by weight: 35 wt % of PMMA resin; 50 wt % of inorganic blocking nano material dispersion; 10 wt % of the nano scratch resistant material dispersion; 0.5 wt % of a leveling agent; and 9.5 wt % of a mixed solvent.

### Comparative Example 2

Referring to FIG. 1, a comparative example 2 provides a four-layer composite structure, which is sequentially composed of a film layer of a combination of a fluorocarbon resin and a nano infrared barrier material, a PET substrate layer, an UV absorbing adhesive layer, and a release film After blending a polyvinyl fluoride and an ATO barrier material into a coating liquid, the coating is directly applied to one side of the PET substrate, and the UV absorbing adhesive is applied to the other side of the PET substrate relative to another side of the infrared barrier layer, and then the release film is coated on the UV absorbing adhesive layer to protect an adhesive layer. Compared to the second embodiment, the comparative example 2 replaces the inorganic blocking nano material dispersion with an ATO dispersion, that is a dispersion of a composite metal tungsten oxychloride doped with a metal element such as cerium (cs) or tin (sn) or cerium (sb) or cerium (bi) at an appropriate ratio.

In the comparative example 2, the film layer of the polyvinyl fluoride and the nano infrared barrier material is composed of the following components by weight: 35 wt % of fluorocarbon resin; 50 wt % of the ATO dispersion; 10 wt % of the nano scratch resistant material dispersion; 0.5 wt % of a leveling agent; and 9.5 wt % of a mixed solvent.

### Comparative Example 3

Referring to FIG. 1, a comparative example 3 provides a four-layer composite structure, which is sequentially composed of a film layer of a combination of a fluorocarbon resin and a nano infrared barrier material, a PET substrate layer, an UV absorbing adhesive layer, and a release film After blending a polyvinyl fluoride and a ITO barrier material into a coating liquid, the coating is directly applied to one side of the PET substrate, and the UV absorbing adhesive is applied to the other side of the PET substrate relative to another side of the infrared barrier layer, and then the release film is coated on the UV absorbing adhesive layer to protect an adhesive layer. Compared to the second embodiment, the comparative example 3 replaces the inorganic blocking nano material dispersion with an ITO dispersion, that is a dispersion of a composite metal tungsten oxychloride doped with a metal element such as cerium (cs) or tin (sn) or cerium (sb) or cerium (bi) at an appropriate ratio.

In the comparative example 3, the film layer of the polyvinyl fluoride and the nano infrared barrier material is composed of the following components by weight: 35 wt % of fluorocarbon resin; 50 wt % of the ITO dispersion; 10 wt % of the nano scratch resistant material dispersion; 0.5 wt % of a leveling agent; and 9.5 wt % of a mixed solvent.

TABLE 1
Comparison of the embodiments and the comparative examples of
the present disclosure, and a ready-made energy saving films.

| | case | | | | | |
|---|---|---|---|---|---|---|
| | | | | | | ready-made |
| | First | Second | Comparative | Comparative | Comparative | energy |
| item | embodiment | embodiment | example 1 | example 2 | example 3 | saving films |
| Infrared block | 56 | 95 | 94 | 61 | 42 | 54 |
| (700~2500 nm, %) | | | | | | |
| Visible light | 73 | 71 | 74 | 65 | 74 | 66 |
| penetration | | | | | | |
| (400~780 nm, %) | | | | | | |
| UV blocking | 99 | 99 | 99 | 99 | 99 | 97 |
| (below 400 nm, %) | | | | | | |
| Weather resistance | Color | Δe = 1.4 | Δe = 3.7 | Δe = 1.8 | Δe = 2.2 | Δe = 5.3 |
| (xenon arc lamp | difference | | | | | |
| 3000hrs) | (Δe) = 1.3 | | | | | |
| Wear resistance | 3h | 3h | 1h | 3h | 3h | 1h |
| ( ASTM D3363) | | | | | | |
| Self-cleaning | good | good | fair | good | good | poor |

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An energy saving film structure comprising a transparent fluorocarbon insulation, a PET substrate layer, an UV absorbing adhesive layer and a release film, wherein the fluorocarbon insulation is bonded to the PET substrate layer, one side of the UV absorbing adhesive layer is attached to the release film, and the other side of the UV absorbing adhesive layer is bonded to the PET substrate layer.

2. The energy saving film structure according to claim 1, wherein the fluorocarbon insulation includes, by weight percentage, 25 to 55 wt % of fluorocarbon resin, 30 to 65 wt % of infrared blocking nano material dispersion, 1 to 15 wt % of nano scratch resistant material dispersion, 0.01 to 1.2 wt % of leveling agent, and 15 to 40 wt % of mixed solvent.

3. The energy saving film structure according to claim 2, wherein the fluorocarbon resin is polyvinyl fluoride.

4. The energy saving film structure according to claim 2, wherein the infrared blocking nano material dispersion has a solid content of 20 to 40 wt %.

5. The energy saving film structure according to claim 2, wherein the infrared blocking nano material dispersion is a dispersion of a composite metal tungsten oxychloride doped with antimony, tin, antimony, bismuth or a combination thereof.

6. The energy saving film structure according to claim 2, wherein an average particle diameter of the infrared blocking nano material dispersion is from 30 nm to 100 nm.

7. The energy saving film structure according to claim 2, wherein an average particle diameter of the nano scratch resistant material dispersion is from 20 nm to 120 nm.
